(19) United States
(12) Patent Application Publication
(10) Pub. No.: US 2025/0285298 A1
(43) Pub. Date: Sep. 11, 2025

(54) SPEED ESTIMATION SYSTEMS AND METHODS WITHOUT CAMERA CALIBRATION

(71) Applicant: NAVER CORPORATION, Gydonggi-do (KR)

(72) Inventors: Jérome REVAUD, Meylan (FR); Yohann Cabon, Montbonnot-Saint-Martin (FR); Julien Morat, Montbonnot-Saint-Martin (FR)

(73) Assignee: NAVER CORPORATION, Gyeonggi-do (KR)

(21) Appl. No.: 19/218,834

(22) Filed: May 27, 2025

Related U.S. Application Data
(63) Continuation of application No. 17/162,353, filed on Jan. 29, 2021, now abandoned.

(51) Int. Cl. G06T 7/246; G06T 7/73; G06V 20/64

(52) U.S. Cl. CPC G06T 7/248; G06T 7/74; G06V 20/64; G06T 2207/20081; G06T 2207/20084; G06T 2207/30252

(57) ABSTRACT

A speed estimation system includes: a detection module having a neural network configured to: receive a time series of images, the images including a surface having a local geometry; detect an object in the time series of images on the surface; determine pixel coordinates of the object in the time series of images, respectively; determine bounding boxes around the object in the time series of images, respectively; determine local mappings, which are not a function of global parameters describing the local geometry of the surface, between pixel coordinates and distance coordinates for the time series of images based on the bounding boxes around the object in the time series of images, respectively; and a speed module configured to determine a speed of the object traveling relative to the surface based on the distance coordinates determined for the time series of images.

### CROSS-REFERENCE TO RELATED APPLICATIONS

The present disclosure is a continuation of U.S. patent application Ser. No. 17/162,353 filed on Jan. 29, 2021. The entire disclosure of the application referenced above is incorporated herein by reference.

### FIELD

The present disclosure relates to speed estimation systems and more particularly to systems and methods for estimating speed vehicles from video, such as from a closed circuit television (CCTV) camera.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Cameras, such as closed circuit television (CCTV) cameras may be used in various environments, such as for surveillance and traffic monitoring. Other hardware can also be used for traffic monitoring. For example, radar sensors can be installed near roadways and used to monitor traffic. As another example, inductive loops can be installed in roadways (e.g., near intersections) and used to monitor traffic. Such hardware, however, may be expensive and cannot be installed quickly and/or on a large scale. For example, inductive loops are typically installed within or below a road surface.

Systems that use cameras for traffic speed monitoring require accurate calibration. Such camera systems, however, may not be calibrated or may require constant recalibration if they are moving, so a homography of the road in these situations may be unknown. Geometry (e.g., 3D shape) of the roadway in view may also not be accounted for, potentially limiting the usefulness to roadways that are flat and straight.

### SUMMARY

In a feature, a speed estimation system includes: a detection module having a neural network configured to: receive a time series of images, the images including a surface having a local geometry; detect an object in the time series of images on the surface; determine pixel coordinates of the object in the time series of images, respectively; determine bounding boxes around the object in the time series of images, respectively; determine local mappings, which are not a function of global parameters describing the local geometry of the surface, between pixel coordinates and distance coordinates for the time series of images based on the bounding boxes around the object in the time series of images, respectively; and a speed module configured to determine a speed of the object traveling relative to the surface based on the distance coordinates determined for the time series of images.

In further features, an averaging module is configured to determine an average speed of the object based on an average of multiple instances of speed of the object in the time series of images.

In further features, the average module performs median filtering on the speeds of the object in the time series of images before determining the average speed.

In further features, the object on the surface is a vehicle on a road.

In further features, a tracking module is configured to generate a track for movement of the object based on the pixel coordinates of the images, respectively.

In further features, the tracking module is configured to track the object in the images using the simple online and realtime tracking (SORT) tracking algorithm.

In further features, the tracking module is configured to disable the determination of the speed of the object when a number of detections of the object in the images is less than a predetermined number.

In further features, the tracking module is configured to disable the determination of the speed of the object when the object is not moving.

In further features, the detection module includes: a feature detection module configured to detect features in one of the time series of images; a regional proposal module configured to, based on the features of the one of the time series of images, propose a region of the one of the images within which the object is present; a regional pooling module configured to pool features within the region to create pooled features; a classifier module configured to determine the classification of the object based on the pooled features; and a bounding module configured to determine the bounding box for the one of the images based on the pooled features.

In further features, the detection module includes a convolutional neural network.

In further features, the convolutional neural network of the detection module executes the Faster-regions with convolutional neural network (Faster-RCNN) object detection algorithm.

In further features: the neural network of the detection module is further configured to: detect a second object in the time series of images on the surface; determine second pixel coordinates of the second object in the time series of images, respectively; determine second bounding boxes around the second object in the time series of images, respectively; determine second local mappings, which are not a function of global parameters describing the local geometry of the surface, between pixel coordinates and distance coordinates for the time series of images based on the second bounding boxes around the second object in the time series of images, respectively; and the speed module is configured to determine a second speed of the second object traveling relative to the surface based on the second distance coordinates determined for the time series of images.

In further features, an average speed module is configured to determine an average speed based on an average of the speed and the second speed.

In further features, the detection module is configured to receive the time series of images from a monocular camera.

In further features, the monocular camera is a pan, tilt, zoom (PTZ) camera.

In further features, the speed module is configured to determine the speed of the object further based on a change in the pixel coordinates from a first one of the images to a second one of the images.

In further features, the neural network is trained to determine the local mappings between pixel coordinates and distance coordinates using Jacobians.

In further features, the local mappings are determined using Jacobians.

In further features, the bounding boxes include three dimensional (3D) bounding boxes, and where the neural network of the detection module is configured to determine the Jacobians based on four pixel coordinates of four lower corners of the 3D bounding boxes.

In further features, the detection module is configured to determine the Jacobians further based on a length of the object and a width of the object.

In further features, the detection module is configured to receive the time series of images from a video source via a network.

In further features, the speed module is configured to determine the speed of the object without stored calibration parameters of a camera.

In a feature, a routing system includes the speed estimation system, and a route module is configured to: determine a route for one of a mobile device and a vehicle based on the speed of the object; and transmit the route to the one of the mobile device and the vehicle.

In a feature, a signaling system includes the speed estimation system, and a signal control module is configured to: determine a timing for a traffic signal based on the speed of the object; and control timing of the traffic signal based on the timing.

In a feature, a method for estimating a speed of an object in a time series of images using a neural network includes: receiving the time series of images, the images including a surface having a local geometry; by the neural network: detecting an object in the time series of images on the surface; determining pixel coordinates of the object in the time series of images, respectively; determining bounding boxes around the object in the time series of images, respectively; determining local mappings, which are not a function of global parameters describing the local geometry of the surface, between pixel coordinates and distance coordinates for the time series of images based on the bounding boxes around the object in the time series of images, respectively; and determining a speed of the object traveling relative to the surface based on the distance coordinates determined for the time series of images.

In a feature, a speed estimation system includes: a first means for: receiving a time series of images, the images including a surface having a local geometry; detecting an object in the time series of images on the surface; determining pixel coordinates of the object in the time series of images, respectively; determining bounding boxes around the object in the time series of images, respectively; determining local mappings, which are not a function of global parameters describing the local geometry of the surface, between pixel coordinates and distance coordinates for the time series of images based on the bounding boxes around the object in the time series of images, respectively; and a second means for determining a speed of the object traveling relative to the surface based on the distance coordinates determined for the time series of images.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example vehicle speed estimation system;

FIG. 2 is a functional block diagram of an example vehicle speed estimation system;

FIG. 3 includes example images of portions of roads captured using cameras with vehicles moving on the roads;

FIG. 4 includes an example implementation of a routing system for routing vehicle traffic;

FIG. 5 includes an example implementation of a signaling system for traffic signaling;

FIG. 6 is a functional block diagram of an example implementation of a speed estimation module;

FIG. 7 includes an example road surface;

FIG. 8 includes a functional block diagram of an example vehicle detection system that may be utilized by the example speed estimation system shown in FIG. 6;

FIG. 9 includes example vehicle images from a training dataset with bounding boxes;

FIG. 10 includes a top view and a side view of an example vehicle with associated inverse Jacobian;

FIG. 11 is a functional block diagram of an example training system;

FIGS. 12A and 12B illustrate an example image including tracks and filtering of tracks from the image;

FIG. 13 includes pseudocode for an example method of determining vehicle speed using input from a camera; and

FIGS. 14 and 15 include example estimated vehicle speeds determined based on two different data sets and actual (ground-truth) speeds of the vehicles in the data sets.

In the drawings, reference numbers may be reused to identify similar and/or identical elements.

### DETAILED DESCRIPTION

The present application involves a data-driven approach to determine speeds of objects (e.g., vehicles) using video from cameras (e.g., closed circuit television cameras) that are uncalibrated (i.e., without known global camera parameters). The approach is based on the observation that the local geometry (e.g., 3D shape) of a road can be accurately estimated based on an object's visual appearance. As a result, the approach described herein is calibration-free and makes no assumption as to the road geometry.

The present application involves training a network to determine local mappings between pixel coordinates and distance coordinates without global parameters describing a local geometry. In an embodiment, local mappings are determined by regressing the Jacobian of the mapping function between pixels and real world (e.g., distance) coordinates at each vehicle's position. This allows the network to directly convert the per-frame vehicle displacements from pixels to distance (e.g., meters) and hence to calculate vehicle speeds. Generally, the Jacobian is a mathematical transformation involving partial derivatives (where the derivative is a slope of an approximation of a line) that accounts for distortions when changing coordinate systems.

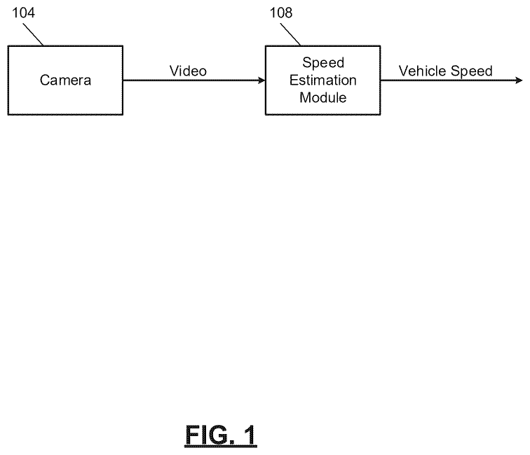

FIG. 1 is a functional block diagram of an example vehicle speed estimation system. While the example of vehicle speed estimation will be described, the present application is also applicable to estimating speeds of other types of objects (e.g., pedestrians, cyclists, runners, tractors, mountain bikers, boats, swimmers, skiers, snowmobilers, etc.) on surfaces (e.g., the ground and/or other types of paths, water, snow, etc.).

In the embodiment shown, a camera 104 captures video of a portion road over which vehicles travel. The road can be planar (no inclines and/or declines) and straight, the road can be planar and include one or more curves, the road can be non-planar (include one or more inclines and/or declines) and straight, or the road can be both non-planar and include one or more curves. The camera 104 captures images at a predetermined rate, such as 60 hertz (Hz), 120 Hz, etc. A time series of the images forms the video.

A speed estimation module 108 estimates the speed of a vehicle on the road using the images from the camera 104 as discussed further below. In various implementations, the speed estimation module 108 may estimate the speed of each vehicle on the road using the images from the camera 104. While the example of the video being captured using the camera 104 is provided, the present application is also applicable to estimating speed of a vehicle using video obtained via a network, such as the Internet, such as from one or more video sources (e.g., YouTube, video games) and/or databases. The present application is also applicable to video not generated by one or more cameras, such as animated video generated to include virtual vehicles on virtual surfaces (e.g., paths or ground).

The speed estimation module 108 may estimate the speed of each vehicle on the road using the images from the camera 104. The speed estimation module 108 may determine an average vehicle speed by averaging the speeds of all of the vehicles, respectively, on the road.

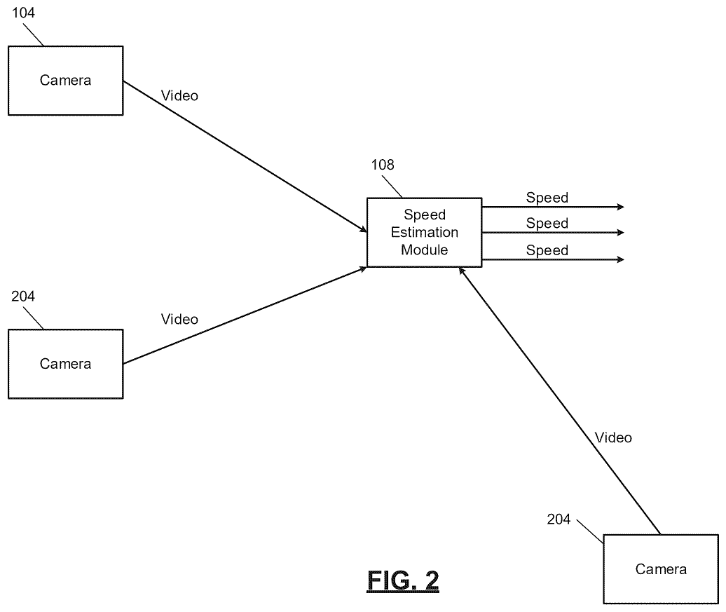

FIG. 2 is a functional block diagram of an example vehicle speed estimation system. As shown, the speed estimation module 108 may receive video from one or more additional cameras, such as cameras 204. The cameras 204 may capture video of different portions of different roads than the camera 104 and/or different parts of the same road as the camera 104. The speed estimation module 108 may estimate speeds of vehicles captured by each of the cameras 104 and 204.

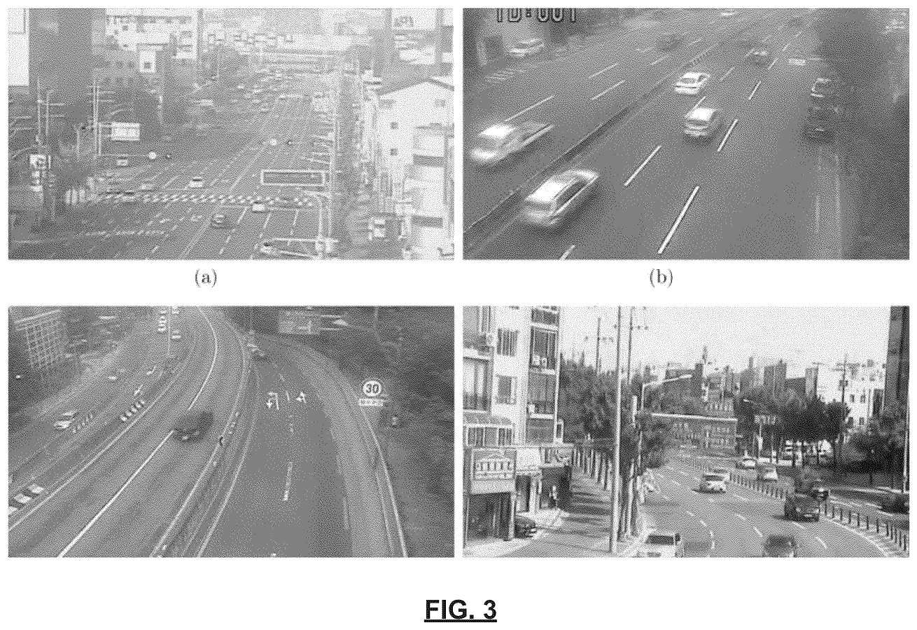

The cameras may have a fixed field of view, or the cameras may be configured to tilt the field of view selectively upwardly and downwardly and/or pan the field of view selectively right and left. In various implementations, the cameras may be cameras of vehicles that move with the vehicles. FIG. 3 includes example images of portions of roads captured using cameras with vehicles moving on the roads. The locations of the cameras may be transmitted by the cameras or determined, for example, based a unique identifier of the camera transmitted with its video.

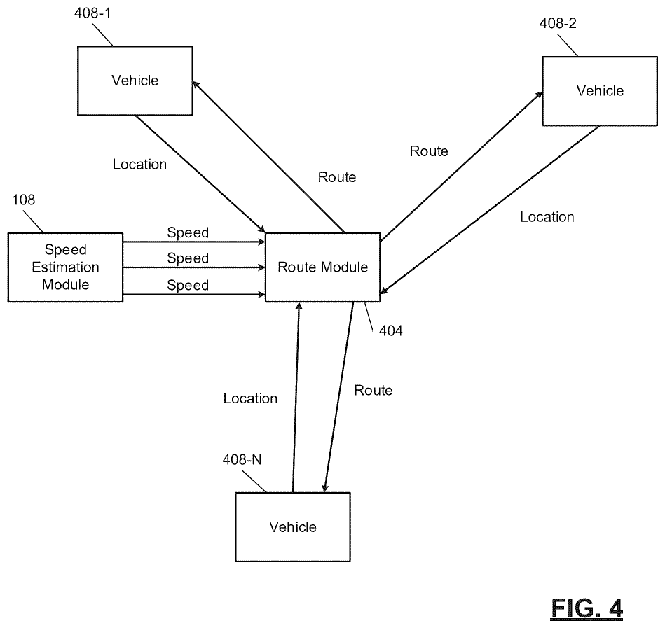

Vehicle speeds estimated by the speed estimation module 108 may be used for one or more purposes. For example, FIG. 4 includes an example implementation of a routing system for routing vehicle traffic. The speed estimation module 108 may transmit the speeds of vehicles at various locations to a route module 404.

The route module 404 may determine a route for a vehicle to move from a starting location to a destination location based on the starting location, the destination location, and the vehicle speeds at one or more locations between starting and destination locations. For example, the route module 404 may determine the fastest possible route from the starting location to the destination location based on one or more of the vehicle speeds at various different locations and set the route for the vehicle to the fastest possible route.

Example vehicles 408-1, 408-2, 408—N(“vehicles 408”) are shown, where N is an integer greater than or equal to 1. In various implementations, the vehicles 408 may be a fleet of autonomous vehicles, semi-autonomous vehicles, or non-autonomous (driver driven) vehicles. The vehicles 408 may navigate or provide directions (e.g., audibly and/or visually) for navigating to their respective destination locations according to the respective routes set by the route module 404.

The route module 404 may also selectively update the route of a vehicle while the vehicle is traveling to its destination location. Each of the vehicles 408 may wirelessly transmit its location to the route module 404. When the vehicle speeds at one or more locations along the present route decrease or fall below a predetermined speed, the route module 404 may update the route to avoid those one or more locations and to follow a route that will allow the vehicle to get to the destination location most quickly. While the example of vehicles 408 has been provided, the present application is also applicable to mobile devices, such as smart phones, tablets, etc. Also, while examples of routing have been provided, the routing module 504 may determine or adjust the route of a vehicle based on one or more of the vehicle speeds for one or more other reasons.

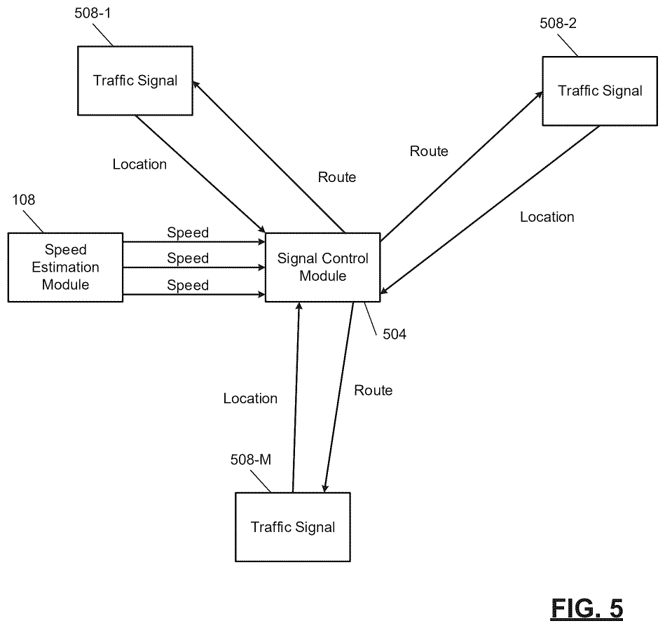

FIG. 5 includes an example implementation of a signaling system for traffic signaling. The speed estimation module 108 may transmit the speeds of vehicles at various locations to a signal control module 504. The signal control module 504 may control timing of traffic signals 508-1, 508-2, 508-M, where M is an integer greater than or equal to 1, based on one or more of the vehicle speeds at or near their respective locations. For example, the signal control module 504 may control the traffic signal at an intersection to increase a period that vehicles are permitted to drive through the intersection in a direction when vehicle speeds in the direction at or near the intersection are less than a predetermined speed or have been less than the predetermined speed for a predetermined period. The signal control module 504 may also control the traffic signal to decrease a period that vehicles are permitted to drive through the intersection in another direction. While examples of controlling signaling have been provided, the signal control module 404 may determine or adjust the timing of one or more traffic signals based on one or more of the vehicle speeds for one or more other reasons.

While example uses of vehicle speed estimated by the speed estimation module 108 have been provided, the present application is also applicable to other uses of one or more of the vehicle speeds.

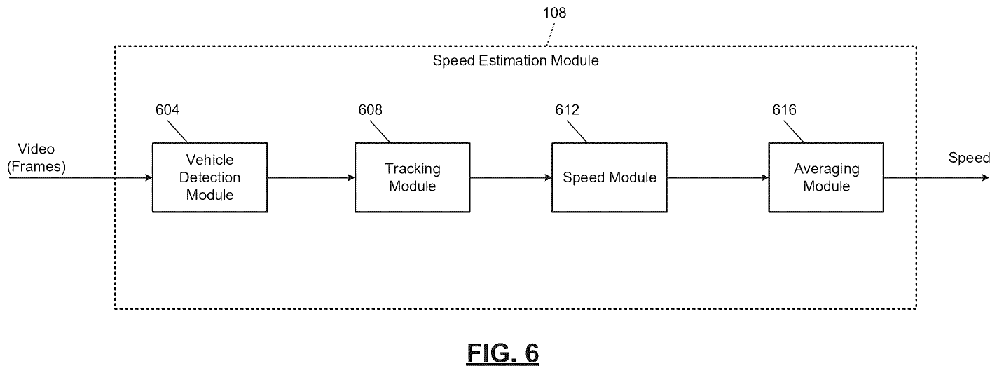

FIG. 6 is a functional block diagram of an example implementation of the speed estimation module 108. A vehicle detection module 604 (or more generally a detection module) detects and determines locations (e.g., pixel coordinates) of one or more vehicles in each frame of the video from a camera. A tracking module 608 tracks each vehicle from frame to frame to create tracks for the vehicles, respectively. The track for a vehicle includes a time series of pixel coordinates for that vehicle.

A speed module 612 determines the speed of a vehicle based on changes in the pixel coordinates of the vehicle over time, such as from image to image, as discussed further below. The speed module 612 may determine an average vehicle speed by averaging the speeds of multiple or all vehicles at a given time. Averaging may include adding the speeds of each vehicle and dividing the sum by the total number of speeds added.

To summarize, the speed estimation module 108 involves a three stage pipeline of detecting and tracking each vehicle and then estimating its speed. More specifically, the speed estimation module 108 performs (1) vehicle detection, (2) vehicle tracking and (3) pixel displacement to speed conversion to determine vehicle speed. Vehicle speed is estimated using a deep network trained specifically for vehicle speed estimation without requiring calibration of the camera and without making any assumptions as to the planarity or straightness of the road. No dedicated vehicle speed sensors are used in the vehicle speed estimation.

In an embodiment, vehicle detection is accomplished by vehicle detection module 604 using an object detector (object detection algorithm) based on a deep network, such as the Faster-regions with convolutional neural network (Faster-RCNN) object detection algorithm, to determine pixel coordinates for a vehicle. Additional information regarding Faster-RCNN can be found in “Faster R-CNN: Towards Real-Time Object Detection with Regional proposal Networks”, by Shaoqing Ren, et al., IEEE Transactions on pattern Analysis and Machine Intelligence, 39 (6): 1137-1149 Jun. 2017, which is incorporated herein in its entirety. The tracking involves connecting the temporal vehicle detections (e.g., 2D bounding boxes) over time to form vehicle tracks. The tracker can either be heuristic (e.g., including a Kalman filter) or trained. The vehicle speed estimation includes converting each track (e.g., the pixel coordinates of a vehicle over time) to displacement (e.g., meters) in a coordinate system aligned onto the road. This may involve using a homography that maps image pixels with the road surface. Once the homography has been determined, vehicle tracks can be projected into real world coordinates for vehicle speed estimation.

The speed estimation module 108 estimates a transform that relates the camera view with the road plane (a homography) in the field of view of the camera. This is similar to but different than calibrating the camera. Accurately estimating the homography provides accurate vehicle speed estimates.

Camera parameters include intrinsic parameters that describe the camera optics (e.g., the principal point, the focal length and distortion coefficients) and extrinsic parameters that describe the position of the camera in the 3D world (e.g., translation and rotation). The concepts discussed herein which are different than camera calibration where calibration parameters are either manually entered by a user or estimated from a frame. The manual entry may include a user annotating multiple points on a road with dimensions. The estimation may assume a straight road and rely on detecting vanishing points as an intersection of road markings (e.g., line markings) or on vehicle motion. Once the camera parameters are known, and assuming a planar road, they directly yield the road homography up to an unknown scaling factor. This factor also needs to be estimated accurately, as all estimated speeds will be proportional to it.

Manual annotations may be used to calibrate camera parameters where several distances are accurately measured on the road plane. A fully automatic approach to calibrate camera parameters may include estimating the scene scale by recognizing vehicles along with their 3D pose, retrieving their 3D model, and aligning the 3D model with its bounding box on the CCTV frame. These camera parameter calibration approaches, however, tend to make inaccurate assumptions, such as: (1) the camera is fixed; (2) the road is planar; and (3) the road is straight. The systems and methods described herein provide accuracy even for use of pan tilt zoom (PTZ) cameras and does not involve any assumption regarding the road geometry.

The speed module 612 performs pixel coordinates to speed conversion. As discussed above, the present application involves estimating average speed of vehicles captured using a camera, such as monocular camera. First, the speed module 612 determines an instantaneous speed for each vehicle at each time (frame of video). Second, an averaging module 616 averages the instantaneous speeds for all of the vehicles at a given time to determine the average speed at that time.

Consider a given vehicle V defined as a point νΣ [symbol] ³ moving on the road in a world 3D (three dimensional) coordinate system. The vehicle trajectory Tᵥ can be denoted as the sequence of positions successively/consecutively occupied by the vehicle over time:

$${T}_{V} = \{ {v}_{t} \vert 0 \leq t \leq T \}$$

where time t varies in the range [0, T]. The average speed of the vehicle (Sᵥ) can be defined as the length of the vehicle's trajectory between two times divided by the period between the two times and can be expressed by the equation:

$${S}_{v} = \frac{1}{T} {\int }_{0}^{T} ‖ dv ‖$$

where dv denotes the infinitesimal displacement of the vehicle and ∥dv∥ denotes its Euclidean norm—the length of the displacement. The true 3D position of the vehicle v may be unknown, so the 2D (two dimensional) projection of the vehicle v on the camera plane (pixel coordinates) is used. More specifically, the 2D track is used where the 2D track is defined as

$$P v = \{ {p}_{0} , … , {p}_{t} , … {p}_{T} \} ,$$

where t corresponds to the image/frame between time 0 and time T, and pₜ includes the 2D x and y pixel coordinates of the vehicle at time t, (xₜ, yₜ).

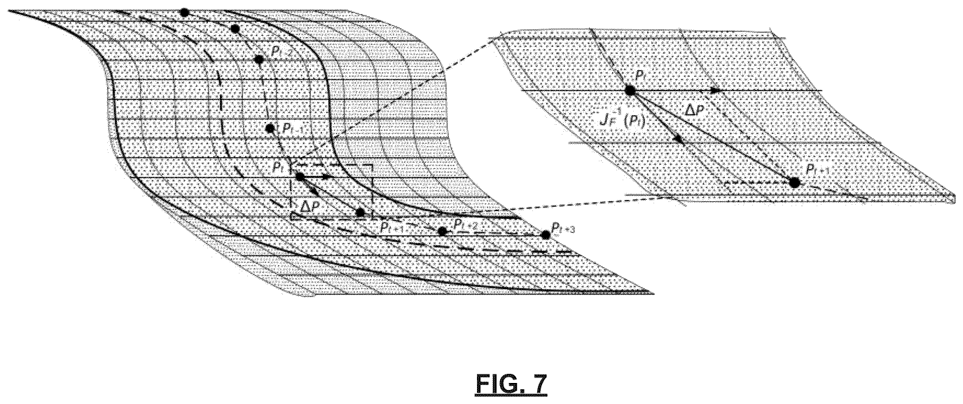

Let F: [symbol] ²→ [symbol] ³ denote a mapping between pixel coordinates and real world coordinates such that F (p)=v. The mapping is one-to-one, as the road usually cannot occlude itself. The example road surface is illustrated on the left of FIG. 7 as a 2D continuous manifold embedded in a 3D real world space. The speed of the vehicle can be expressed as:

$${S}_{v} = \frac{1}{T} {\int }_{0}^{T} ‖ dFp ‖ .$$

The left of FIG. 7 illustrates a trajectory Tᵥ of a vehicle v on a road at consecutive frames t−2, . . . , t+2. The 3D shape of the 2D road manifold is highlighted with a gray grid where each square corresponds to a 1 meter×1 meter area. In the example, the road is neither straight nor flat. F: [symbol] ²→ [symbol] ³ denotes the mapping between image pixels and the 3D world coordinates.

The right of FIG. 7 is a close up view of a portion of the left of FIG. 7 on the trajectory at time t→t+1. The product J_{F}(pₜ)Δₚ between the Jacobean of F at pₜ and the displacement in pixels Δp=pₜ₊₁−pₜ produces a first order approximation of the displacement in the 3D real world in a unit (e.g., metric) system.

The speed module 612 determines the instantaneous speed of a vehicle based on or as a sum of small per-frame displacements:

$${S}_{v} = \frac{1}{T} {\int }_{0}^{T} ‖ dFp ‖$$

$${S}_{v} = \frac{1}{T} {\sum }_{t = 0}^{t = T} ‖ F ( {p}_{t + 1} ) - F ( {p}_{t} ) ‖$$

The mapping function F (p) (the homography) depends on the 3D geometry of the road manifold and on parameters of the camera. Since the mapping function F is continuous and differentiable everywhere on the road, the present application involves use of the linear transformation represented by its Jacobian J

J_{F}(p)∈ [symbol] ^{3×2},

which is an accurate first order approximation of F near p, i.e.,

$$F ( x ) ≃ {J}_{F} ( p ) ( x - p ) + F ( p ) ,$$

$$with$$

$${J}_{F} ( p ) = [ \frac{\partial F}{\partial x} ( p ) , \frac{\partial F}{\partial y} ( p ) , ]$$

Δpₜ₊₁−pₜ is small by design, so x=p+1 and p=pₜ can be used in the equations above to produce:

$${S}_{v} = \frac{1}{T} {\sum }_{t = 0}^{T - 1} ‖ F ( {p}_{t + 1} ) - F ( {p}_{t} ) ‖$$

$${S}_{v} ≃ \frac{1}{T} {\sum }_{t = 0}^{T - 1} ‖ {J}_{F} ( p ) ( {p}_{t + 1} - {p}_{t} ) + F ( {p}_{t} ) - F ( p ) ‖$$

$${S}_{v} = \frac{1}{T} {\sum }_{t = 0}^{T - 1} ‖ {J}_{F} ( p ) ( {p}_{t + 1} - {p}_{t} ) ) ‖$$

$${S}_{v} = \frac{1}{T} {Σ}_{t = 0}^{T - 1} ‖ {J}_{F} ( p ) Δ p ) ‖ ,$$

where Δp=pₜ₊₁−pₜ is the pixel displacement of vehicle V between times (frames) t and t+1. In other words, the speed module 612 estimates the speed of a vehicle based on Jacobian at the vehicle's position p and the change in pixel coordinates over a period between two images/frames.

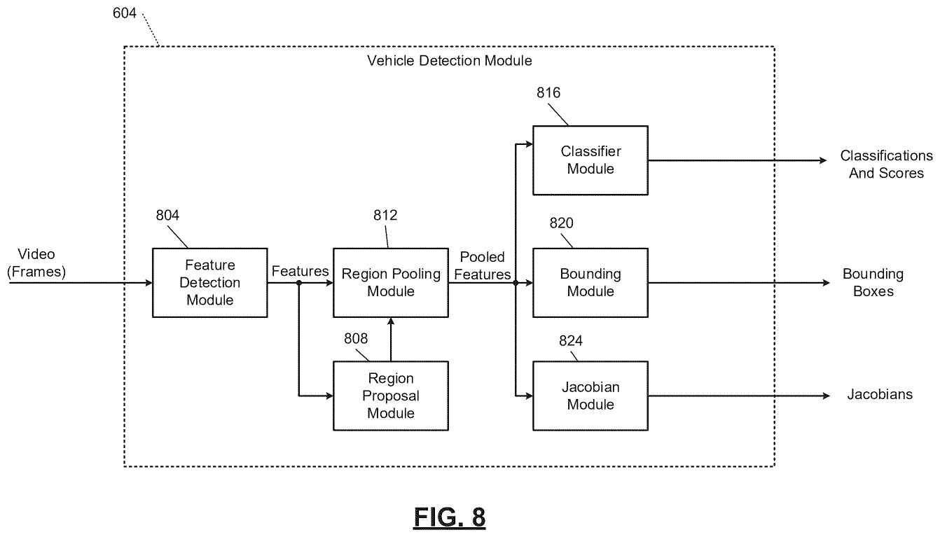

FIG. 8 includes a functional block diagram of an example vehicle detection system 604 that may be utilized by the speed estimation system 108 shown in FIG. 6. A feature detection module 804 receives a video produced, for example, by a camera. The feature detection module 804 identifies features in a frame/image of the video at a time using a feature detection algorithm. A region proposal module 808 proposes regions of interest in the frame based on the features using a region proposal algorithm. A region pooling module 812 pools features based on the proposed regions to produce pooled features.

A classifier module 816 classifies objects formed by the pooled features using an object classification algorithm. One possible classification of objects includes vehicles. The classifier module 816 may also determine scores for each classified object, where the score of an object indicates a relative confidence of the classification determined for the object.

A bounding module 820 determines 2D bounding boxes that bound outer edges of the objects identified. The bounding module 820 may also determine coordinates (p) of the objects, such as coordinates of centers of the bounding boxes. A Jacobian module 824 determines a Jacobian (J_{F}) for each object as described above.

In an embodiment shown in FIG. 8, the Faster-RCNN is modified to jointly (1) detect vehicles in the video frames and (2) estimate local mappings between pixel coordinates and distance coordinates (which are not a function of global parameters) using the Jacobian J_{F} as described above. The modified Faster-RCNN may be applied to each video frame to obtain a set of vehicle detections, each having an associated bounding box and a local mappings between pixel coordinates and distance coordinates determined using a Jacobian.

In the embodiment shown in FIG. 8, the modified Faster-RCNN is a deep neural network that includes a ResNet-50 backbone (in the feature detection module 804) followed by one or more region proposal layers (in the region pooling module 812 and region proposal module 808, for example). For pooled features of each video frame output by the region pooling module 812, a region proposal (i.e., a 2D bounding box in the image) is output by bounding module 820 and a classification (e.g., car, truck, bus, motorcycle) and a confidence score is output by the classifier module 816. Region proposals with low confidence scores are discarded by the vehicle detection module 604. Objects not having a predetermined classification (e.g., vehicles) may also be discarded.

In addition, the modified Faster-RCNN illustrated in FIG. 8 includes a Jacobian module 824 for determining for each video frame local mappings between pixel coordinates and distance coordinates, advantageously doing so without global parameters describing the local geometry of the image frame. In an embodiment, the Jacobian module 824 includes another regression branch that predicts for each region proposal a 3×2 matrix J_{F}⁻¹(p) corresponding to the inverse of a Jacobian. The inverse of a Jacobian may scale proportionally to the vehicle's size. In various implementations, the Jacobian module 824 may be implemented separately from the modified Faster-RCNN. Implementation as shown in FIG. 8, however, may provide increased computational efficiency relative to independent implementation for the regression of the Jacobians.

Generally, the Jacobian is used to describe the local geometry of the road manifold with respect to the camera in terms of orientation and scale. Since the vehicle is in contact with the road, the Jacobian module 824 estimates the Jacobian based on the visual appearance of the vehicle.

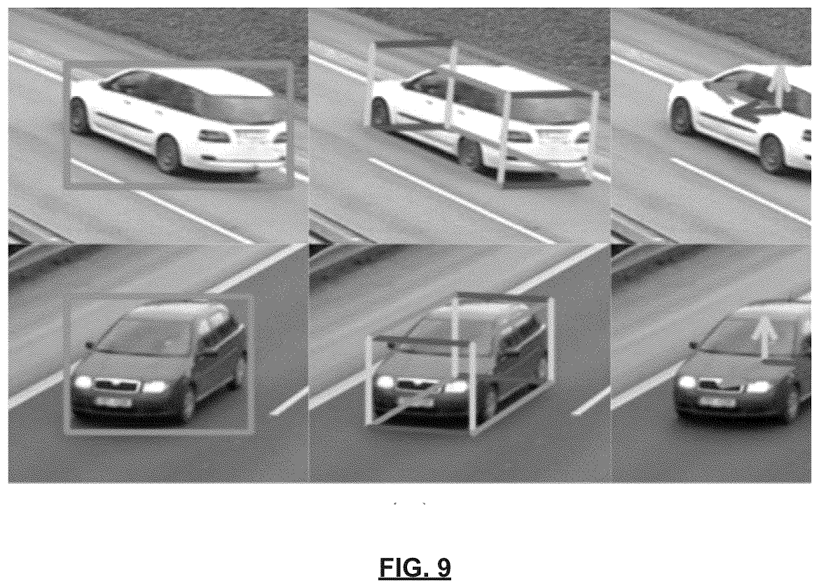

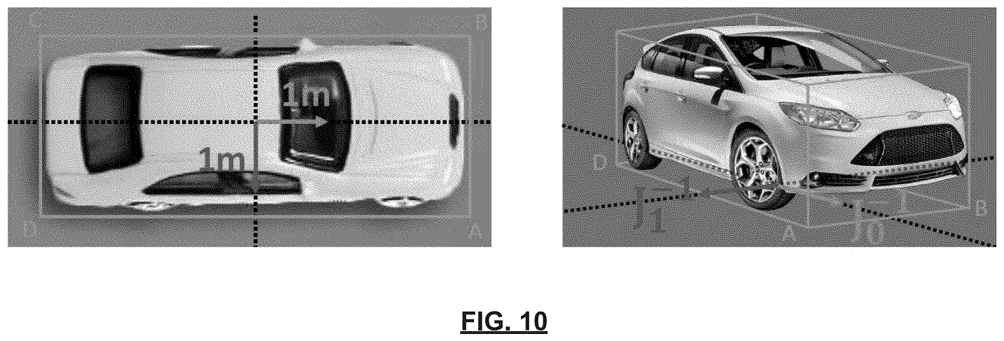

FIG. 9 includes example vehicle images from a training dataset with 2D and 3D bounding boxes. FIG. 10 includes a top view and a side view of an example vehicle with associated inverse Jacobian J_{F}⁻¹=[J₀⁻¹J₁⁻¹]. The inverse Jacobian corresponds to the displacement in pixels when the vehicle moves one unit (e.g., meter) forward (J₀⁻¹) on the road plane or one unit (e.g., meter) to the side (J₁⁻¹) on the road plane.

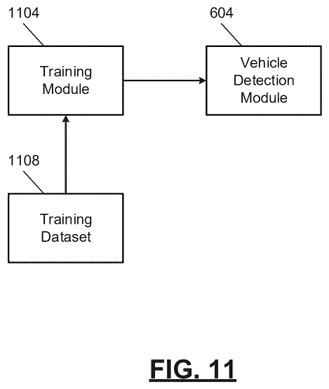

FIG. 11 is a functional block diagram of an example training system. A training module 1104 trains the vehicle detection module 604 (and more specifically the Jacobian module 824) using a training dataset 1108 in a supervised manner. The training dataset 1108 includes images of vehicle proposals and their inverse Jacobians, respectively. In addition to the loss functions already used in the modified Faster-RCNN, the training module 1104 trains the vehicle detection module 604 to minimize an element-wise smooth regression loss, which can be described by:

$${L}_{Jacobian} ( \{ {J}_{i} \} ) = \frac{1}{N} {Σ}_{i} \vert {J}_{i} - {J}_{i}^{*} \vert ,$$

where Jᵢ=J_{F}⁻¹(pᵢ) is the inverse Jacobian regressed by the network for the proposal pᵢ, i∈{1, . . . , N} and Jᵢ* is the corresponding ground-truth inverse Jacobian.

To train the vehicle detection module 604 and determine the ground-truth Jᵢ*, the training dataset 1108 is used and includes images of vehicles annotated with their 2D and 3D bounding boxes. For example only, the training dataset 1108 may include the BoxCars116k dataset or another suitable training dataset. Example images of vehicles including 2D and 3D bounding boxes are provided in FIG. 9. The training dataset 1108 includes images of vehicles of various different sizes, from various different viewpoints, and in various different scales.

The Jacobian module 824 is trained to determine the Jacobian and the inverse Jacobian from the 3D bounding box of a vehicle. The 3D bounding box of a vehicle includes a set/list of the 8 corners of the 3D bounding box B=[cᵢ]_{i=1 . . . 8} where each corner cᵢ=(cₓᵢ, c_{yi}) includes the pixel coordinates of that corner of the image.

Let F⁻¹= [symbol] ³→ [symbol] ² denote the inverse mapping of F, i.e., F⁻¹ (v)=p projects a 3D point v on the road manifold to the image in pixel coordinates p. Assume that the world coordinate system is centered and aligned with vehicle V, such as illustrated in FIG. 9. The Jacobian is defined as J_{F}_{^{−1}}=J_{F}⁻¹=[J₀⁻¹J₁⁻¹], where

$${J}_{0}^{- 1} = \frac{\partial {F}^{- 1}}{\partial x} ≃ {F}^{- 1} ( {v}_{x + 1} - v )$$

$$and$$

$${J}_{1}^{- 1} = \frac{\partial {F}^{- 1}}{\partial y} ≃ {F}^{- 1} ( {v}_{y + 1} - v )$$

respectively represent the displacement in pixels of vehicle V in the camera view when the vehicle moves in the real world by one unit (e.g., 1 meter) forward (v=(X,Y,Z)→vx+1=(X+1,Y,Z) and by one unit (e.g., 1 meter) sideways (v=(X, Y,Z)→vy+1=(X,Y+1,Z).

Given the coordinates of the bounding box, the Jacobian module 824 can approximate the inverse Jacobian J_{F}⁻¹ with

$${J}_{0}^{- 1} = \vec{\frac{D A + C B}{2 L}} , and {J}_{1}^{- 1} = \vec{\frac{C D + B A}{2 W}} ,$$

where A, B, C, and D are the coordinates of the bottom corners of the 3D bounding box (e.g., see FIG. 9) and L,W>0 are the respective length (L) and width (W) of the vehicle V, such as in meters.

Once the per frame/image vehicle detection information is obtained, the tracking module 608 tracks the displacement Tᵥ (see equations above) of each vehicle v in the video. The tracking module 608 may use a tracking algorithm, such as the simple online and realtime tracking (SORT) tracking algorithm or another suitable tracking algorithm. The SORT tracking algorithm may be simple and fast and is based on a Kalman filter. Additional information regarding the SORT algorithm can be found in “Simple Online and Realtime Tracking” by Alex Bewley, et al., ICIP pages 3646-3468, IEEE, 2016, which is incorporated herein in its entirety. The present application is also applicable to other tracking algorithms.

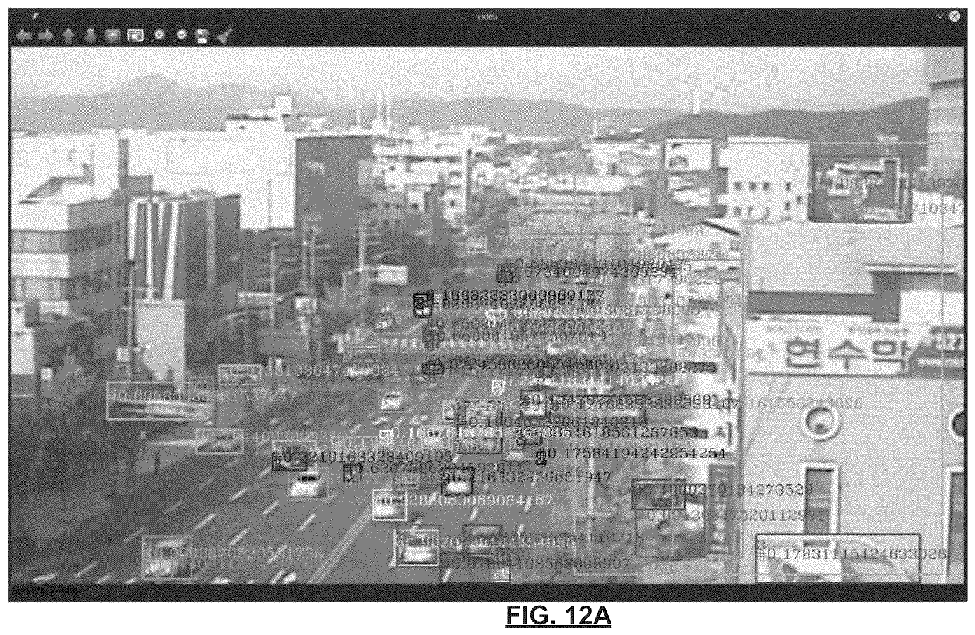

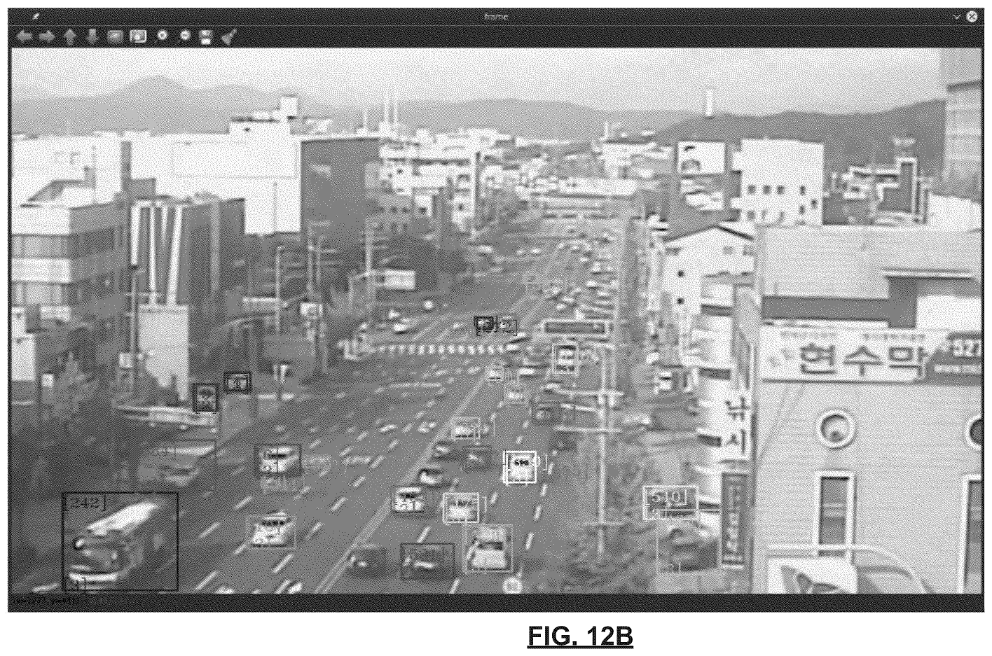

The tracking algorithm may match detected boxes in successive frames. The matching may prioritize the matching of new detections with confident tracks, such as long tracks that already contain more than a predetermined number of detections. The predetermined number is an integer greater than or equal to 1 and may be, for example, 5 or more. The tracking algorithm may also remove false detections, such as tracks that include less than the predetermined number of detections and/or that are for vehicles that are not moving. FIGS. 12A and 12B illustrate examples of filtering. FIG. 12A includes all detections. FIG. 12B include filtered tracks having at least the predetermined number of detections.

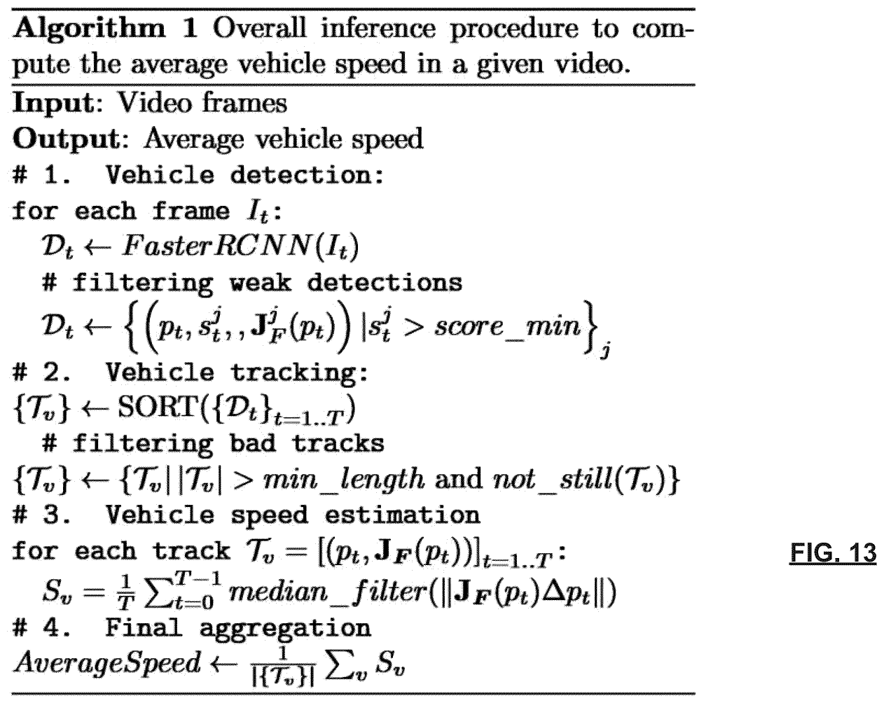

FIG. 13 includes pseudocode for an example method (algorithm) to determine vehicle speed using input from a camera. Given input video from the camera, (#1) the first vehicle detection module 604 may execute the Faster-RCNN on each frame Iₜ independently to get a set of Nₜ vehicle detections
Dt={(pₜ, sₜ^{j},, J_{F}^{j}(pₜ)}_{J=1, . . . N}_{ₜ}, where pₜ^{j} denotes the 2D position of the vehicle vⱼ, sₜ^{j} is its confidence score, J_{F}⁻¹ (pₜ) is its inverse Jacobian determined (regressed) by the Jacobian module 824. The tracking module 608 removes detections with low scores, such as confidence scores less than a predetermined value.

Next (#2), the tracking module 608 temporally aggregates detections into a set of vehicle tracks {Tᵥ}, such as using the SORT algorithm. Next (#3), the speed module 612 determines the average vehicle speed for each track using the equation above. In various implementations, the speed module 612 may use median filtering to make the vehicle speed estimation more robust. Next (#4), the speed module 612 averages the vehicle speeds of each of the vehicles by summing the speed of each vehicle and dividing by the total number of vehicles used to determine the sum.

#2 in FIG. 13 involves removing tracks that are too short (e.g., length or number of detections less than a predetermined value) and tracks for vehicles that are not moving (still). #1 involves removing weak detections, such as detections having a confidence score that is less than a predetermined value.

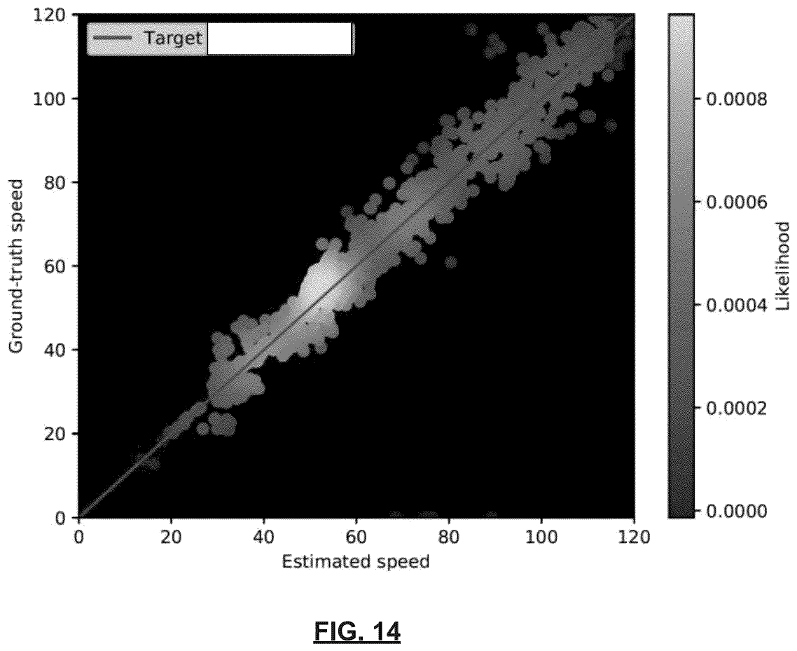

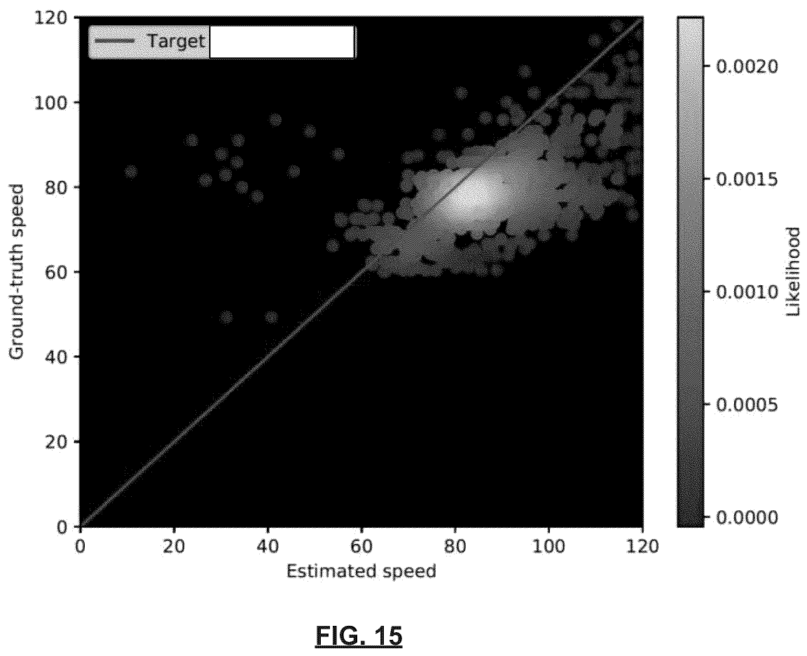

FIGS. 14 and 15 include example estimated vehicle speeds determined based on two different data sets and actual (ground-truth) speeds of the vehicles in the data sets. Roads with curves and/or one or more inclines and/or declines were present in the data sets. As illustrated, the vehicle speeds as estimated herein are accurate. As discussed above, the systems and methods described herein do not require calibration of the camera.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A speed estimation system comprising:
a detection module having a neural network configured to:
receive a time series of images, the images including a surface having a local geometry;
detect an object in the time series of images on the surface;
determine pixel coordinates of the object in the time series of images, respectively;
determine two dimensional (2D) bounding boxes around the object in the time series of images, respectively;
determine local mappings, which are not a function of global parameters describing the local geometry of the surface, between pixel coordinates and distance coordinates for the time series of images based on the 2D bounding boxes around the object in the time series of images, respectively; and
a speed module configured to determine a speed of the object traveling relative to the surface based on the distance coordinates determined for the time series of images;
wherein the detection module is configured to determine the local mappings using Jacobians.

2. The speed estimation system of claim 1 further comprising an averaging module configured to determine an average speed of the object based on an average of multiple instances of speed of the object in the time series of images.

3. The speed estimation system of claim 2 wherein the averaging module performs median filtering on the speeds of the object in the time series of images before determining the average speed.

4. The speed estimation system of claim 1 wherein the object on the surface is a vehicle on a road and the surface is planar.

5. The speed estimation system of claim 1 further comprising a tracking module configured to generate a track for movement of the object based on the pixel coordinates of the images, respectively.

6. The speed estimation system of claim 5 wherein the tracking module is configured to track the object in the images using the simple online and realtime tracking (SORT) tracking algorithm.

7. The speed estimation system of claim 5 wherein the tracking module is configured to disable the determination of the speed of the object when a number of detections of the object in the images is less than a predetermined number.

8. The speed estimation system of claim 5 wherein the tracking module is configured to disable the determination of the speed of the object when the object is not moving.

9. The speed estimation system of claim 1 wherein the detection module includes:
a feature detection module configured to detect features in one of the time series of images;
a regional proposal module configured to, based on the features of the one of the time series of images, propose a region of the one of the images within which the object is present;
a regional pooling module configured to pool features within the region to create pooled features;
a classifier module configured to determine the classification of the object based on the pooled features; and
a bounding module configured to determine the 2D bounding box for the one of the images based on the pooled features.

10. The speed estimation system of claim 1 wherein the detection module includes a convolutional neural network.

11. The speed estimation system of claim 10 wherein the convolutional neural network of the detection module executes the Faster-regions with convolutional neural network (Faster-RCNN) object detection algorithm.

12. The speed estimation system of claim 1 wherein:
the neural network of the detection module is further configured to:
detect a second object in the time series of images on the surface;
determine second pixel coordinates of the second object in the time series of images, respectively;
determine second 2D bounding boxes around the second object in the time series of images, respectively;
determine second local mappings, which are not a function of global parameters describing the local geometry of the surface, between pixel coordinates and distance coordinates for the time series of images based on the second 2D bounding boxes around the second object in the time series of images, respectively; and
the speed module is configured to determine a second speed of the second object traveling relative to the surface based on the second distance coordinates determined for the time series of images,
wherein the detection module is configured to determine the second local mappings using second Jacobians.

13. The speed estimation system of claim 12 further comprising an average speed module configured to determine an average speed based on an average of the speed and the second speed.

14. The speed estimation system of claim 1 wherein the detection module is configured to receive the time series of images from a monocular camera.

15. The speed estimation system of claim 14 wherein the monocular camera is a pan, tilt, zoom (PTZ) camera.

16. The speed estimation system of claim 1 wherein the speed module is configured to determine the speed of the object further based on a change in the pixel coordinates from a first one of the images to a second one of the images.

17. The speed estimation system of claim 1 wherein the neural network is trained to determine the local mappings between pixel coordinates and distance coordinates using Jacobians.

18. (canceled)

19. The speed estimation system of claim 17
wherein the neural network of the detection module is trained to determine a Jacobians and the inverse of the Jacobian from a 3D bounding boxes of an object.

20. The speed estimation system of claim 17 wherein the neural network of the detection module is trained to determine the Jacobians further based on a length of the object and a width of the object.

21. The speed estimation system of claim 1 wherein the detection module is configured to receive the time series of images from a video source via a network.

22. The speed estimation system of claim 1 wherein the speed module is configured to determine the speed of the object without stored calibration parameters of a camera.

23. A routing system, comprising:
the speed estimation system of claim 1; and
a route module configured to:
determine a route for one of a mobile device and a vehicle based on the speed of the object; and
transmit the route to the one of the mobile device and the vehicle.

24. A signaling system, comprising:
the speed estimation system of claim 1; and
a signal control module configured to:
determine a timing for a traffic signal based on the speed of the object; and
control timing of the traffic signal based on the timing.

25. A method for estimating a speed of an object in a time series of images using a neural network, comprising:
receiving the time series of images, the images including a surface having a local geometry;
by the neural network:
detecting an object in the time series of images on the surface;
determining pixel coordinates of the object in the time series of images, respectively;
determining two dimensional (2D) bounding boxes around the object in the time series of images, respectively;
determining local mappings, which are not a function of global parameters describing the local geometry of the surface, between pixel coordinates and distance coordinates for the time series of images based on the 2D_bounding boxes around the object in the time series of images, respectively; and
determining a speed of the object traveling relative to the surface based on the distance coordinates determined for the time series of images;
wherein determining the local mappings includes determining the local mappings using Jacobians.

26. (canceled)

27. A speed estimation system comprising:
a detection module having a neural network configured to:
receive a time series of images, the images including a surface;
detect an object on the surface in an image of the time series of images;
determine pixel coordinates of a two dimensional (2D) bounding box around the object in the image;
determine a Jacobian based on the image and the 2D bounding box; and
a speed module configured to determine a speed of the object traveling relative to the surface based on the Jacobian and the pixel coordinates of the 2D bounding box.

28. The speed estimation system of claim 27 wherein the Jacobian provides a local mapping between pixel coordinates and distance.
